(19) United States
(12) Patent Application Publication
(10) Pub. No.: US 2008/0270358 A1
(43) Pub. Date: Oct. 30, 2008

(54) SYSTEM FOR CREATING PUBLICATIONS

(76) Inventors: Ehud Chatow, Palo Alto, CA (US); Andrew E. Fitzhugh, Menlo park, CA (US); Nathan M. Moroney, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/741,718

(22) Filed: Apr. 27, 2007

(51) Int. Cl. G06F 17/30

(52) U.S. Cl. 707/3; 707/E17.014

(57) ABSTRACT

A publishing system provides a publisher interface that is dedicated to receive information about creating a publication and that is also dedicated to initiate a search of an information store. The information store contains information about different members who can contribute to various phases of publication creation. The information store is searched to identify at least one member who can contribute to the creation of the publication.

### BACKGROUND

Desktop publishing combines a personal computer and page layout software to create publications. Desktop publishers can create page layouts with text, graphics, photos and other visual elements.

Professional publishing involves development, acquisition, marketing, printing and distribution of newspapers, magazines, books, literary works, musical works, software and other works. Professional publishers have a detailed knowledge of the various aspects of publication.

### BRIEF DESCRIPTION OF THE DRAWINGS

FIG. 1 is an illustration of a system in accordance with an embodiment of the present invention.

FIG. 2 is an illustration of a method of using the system of FIG. 1.

FIG. 3 is an illustration of distributed printing in accordance with an embodiment of the present invention.

FIG. 4 is an illustration of a method of providing a publishing service in accordance with an embodiment of the present invention.

FIG. 5 is an illustration of a client machine and a server in accordance with an embodiment of the present invention.

FIG. 6 is an illustration of another method of using the system of FIG. 1.

### DETAILED DESCRIPTION

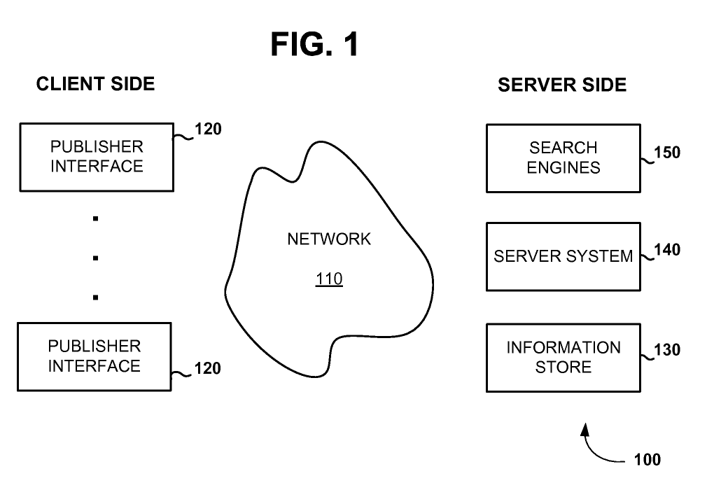

Reference is made to FIG. 1, which illustrates an exemplary system 100 for creating publications. The system 100 includes a server side that communicates with a client side over a network 110. The network 110 is not limited to any particular type. The network 110 could be a computer network such as a LAN, the Internet, a cellular network, a peer-to-peer network, a personal area network (e.g., a network that uses Bluetooth), etc.

The client side includes a plurality of publisher interfaces 120. As an example, a publisher interface 120 may be browser-based. A browser-based interface can download web pages and other information from the server side, and upload information to the server side.

A publisher interface 120 is not limited to a browser. In some embodiments, a publisher interface 120 may be a standalone program such as a desktop publisher.

A party uses a publisher interface 120 to manage the creation of a publication. Such a party will be referred to as a “publisher.”

The server side includes an information store 130 for storing information about different parties who can contribute to various phases of publication creation and delivery. Parties such as content providers, designers, editors, and advertisers can contribute to the various phases of publication creation, while parties such as print service providers can contribute to publication delivery. The information store 130 may contain many different parties per category. A party could be an individual, a group of people, an association, a corporation, a government, etc.

These parties may be required to sign up as members to a service. The information store 130 could also include the membership information. Members can utilize the publisher interfaces 120 to store their information in the information store 130.

The information in the store 130 allows a publisher to identify one or more members who can contribute to the creation of the publisher's publication. Examples of such information are provided below.

The server side also includes a server system 140 for providing a publisher interface that is dedicated to receive information about creating a publication and that is also dedicated to initiate a search of the information store 130. The information store 130 is searched to identify at least one member who can contribute to creating the publication.

The term “providing a publisher interface” means providing the entire interface 120 or a portion thereof so the interface 120 is dedicated to performing specific functions (e.g., so it can receive the publication information and search the information store 130). As a first example, the server 140 provides the entire interface 120 by providing a dedicated standalone program to the client side. As a second example, the server 140 provides web pages or applets or other functionality to the client side. When loaded into a general-purpose web browser, this functionality turns the general-purpose web browser into a dedicated web browser that can receive the publication information and initiate a search on the information store 130. Even if a browser or standalone program is so dedicated, it can still perform other functions.

The server side also includes search capability in the form of one or more search engines 150. A conventional search engine 150 may be used to match information submitted by the publisher with information stored in the information store 130. In some embodiments, the publisher interface 120 submits the publication information to a search engine 150. In other embodiments, as in the case of a standalone program, the publisher interface 120 may have search capability and may perform the search itself.

In some embodiments, a publisher interface 120 might be able to access the information store 130 directly, without the need for a search engine 150. For instance, simple manual searches from listings and sorted data bases may be performed.

In some embodiments, the information store 130 and search engines 150 may be controlled by a single service provider. For instance, the information store 130 and search engine(s) 150 could be found on one or more servers of the server system 140. In some embodiments, the entire information store 130 could be proprietary. In some embodiments, a portion of the information store 130 could be propriety, with the remainder being available to the public.

In some embodiments, the information store 130 and search engine 150 could be controlled and maintained by different parties. For instance, one party stores the information in an information store 130, and makes the information store 130 available to another party, which has the engines 150 for searching the information store 130.

The information store can include one or more databases. Multiple databases could be stored in a central location, or networked databases could be spread out over different locations. There could be a plurality of information stores 130 maintained by different parties.

The source of information that is searched is not limited to an information store 130. Other searchable content (e.g., public databases, web-addressable content) may be searched as well.

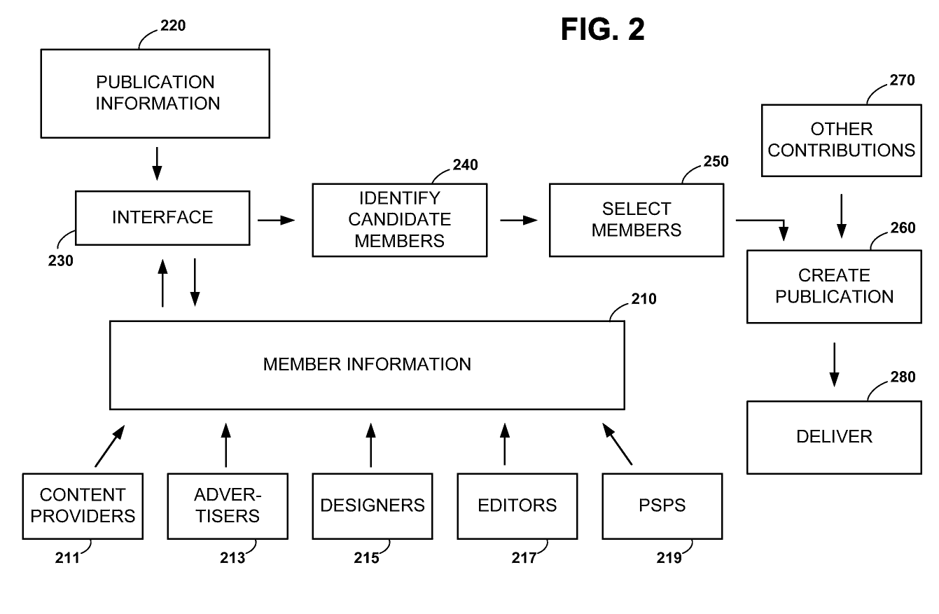

Reference is now made to FIG. 2, which illustrates a method of using the system 100 to create a publication. In the example of FIG. 2, the information store contains information 210 about the following types of members: content providers 211, advertisers 213, designers 215, and editors 217.

Content providers 211 could store their content in an information store or provide links to their content. The content providers 211 could also specify rights, cost per content, type of people who would be interested in their content, etc. Content providers 211 could also specify the types of publications where their content can be published or used.

Advertisers 213 could specify different forms of advertisement. Advertisers 213 could specify cost per advertisement, intended targets, etc.

Designers 215 could act as consultants for the overall appearance of a publication or could directly perform specific creative tasks. For instance, a premium publication might contract with a font designer to create a custom font to be used by a layout designer, or to create document or section templates. Designers 215 could store sample templates and style sheets. Designers 215 could provide sets of instructions for creating themes. Designers 215 could review image and graphical content and could make recommendations or edit these images or graphical content.

Editors 217 may provide their credentials, links to previous publications, previous work examples, cost of service, price ranges for previous work, ratings (e.g., “5 star ratings”) and rankings by publishers or members or both, testimonials by previous customers, areas of expertise, educational background, etc.

To create a publication, a publisher accesses a publisher interface 230, which queries the publisher for information 220 about the publication. For example, the publisher interface 230 might display a set of forms (e.g., html forms, pdf fillable files) that the publisher fills in. The publication information 220 might include circulation, content type, delivery type, advertisement subsidization and other cost estimates. The publication information 220 might include tags, keywords or descriptions of the publisher's publication. For a publication with online visibility, the amount and content of reader comments or reviews and coincident purchases could be used. The publication information 220 might include other information that will allow members to determine whether they can (and want to) contribute to the publication.

The submitted information is processed by a publication service provider. The publication service provider uses a search engine to search the member information 210 to identify a list 240 of candidate members who might be (but are not necessarily) interested in creating the publication. The list 240 might include sample work, credentials, prices, profiles, and other information that allows the publisher to select the members. The publication service provider could also provide user feedback about the various members, for example as a star rating and customer testimonials.

The search engine 230 can actively rank the candidate members. Candidate members could be ranked by a rating or a relative ranking as provided by previous collaborators, cost of services quotes, areas of specialization, user endorsements and other competitive characteristics, such as the ability to meet time-critical deadlines.

Instead of submitting a list 240 of candidate members directly to publisher, the publication service provider might identify different members and ask them to submit bids 240 to the publisher. Those members who are interested will submit the bids 240 to the publisher. Interested parties could submit their bids 240 via the publisher interface 230 or by some other means (e.g., e-mail).

The publisher then selects the members 250 who will create the publication. The publisher can then utilize the publisher interface 230 to notify the members who were selected. The number of members selected will be specific to the publication being created. For some publications, a single member could be selected to create a publication. For other publications, different members could be selected to perform different functions. For still other publications, more than one member could be selected to perform the same function.

The selection of members 250 can also involve agreeing upon specific content and advertisements, and agreeing on a level of advertising that a publisher is willing to allow. A publisher might be willing to pay full cost to create a publication that does not contain advertising. Or a publisher might accept a certain amount of advertising in a publication so the cost is subsidized in part by advertisements. The selection of members 250 can also involve obtaining Intellectual Property rights in selected content and agreeing to royalty payments.

The selected members 250 then create the publication 260. There is no particular manner in which the publication is created. Certain members may work under their own supervision, or they might be supervised by one or more editors 217.

A publication may be created from a template. Different members make their contributions to the template (e.g., by adding content, advertisements, etc.).

A publication may be created over multiple iterations, where each iteration includes sending a template from member to member. During each iteration, a member could modify or remove its previous contribution, or make an additional contribution.

In another example, a publication is created sequentially, in which a member supplies its contribution, and then passes its work to the next member. For example, a designer adds designs to a publication, and passes the semi-completed publication to a content provider. The content provider adds its content and then passes the semi-completed publication to the next content provider. After content has been added, the semi-completed publication is passed around to different advertisers, who add their advertisements. During this process, each member limits the amount of contribution that can be added by the next member. Additional iterations can also be performed.

In another example, designers, content providers and advertisers submit their information to editors, who arrange the information into a publication. The editors arrange the information manually or through an automated process.

In yet another example, different members own different predefined parts of the publication so the publication can be created in parallel. Many of the different members either focus on providing templates or highly refined contributions. A designer provides a template for a book cover page. An advertiser provides a full bleed color advertisement targeted to a specific demographic, etc. A professional editor proof reads the text of an article. A photographer manually edits a cover image. Likewise many of the different members work on individual components without access to the entire custom content.

In addition to contributions by the selected members, the publication could include contributions 270 by the publisher and subscribers. The publisher's contributions could include public and proprietary content, designs and advertising. Subscribers could also supply content to the contributors. Subscribers identify (e.g., sign up) recipients who will receive the customized instances.

Quality control of the publication could be performed in a variety of ways and at different levels. The publisher interface can allow a publisher to preview a publication as it is being created. This might be done electronically, using a form or display technology to assess how specific content templates would work for their content.

Feedback from publishers can also be used as a form of quality control. For instance, contributions can be progressively validated and ranked by publishers. Designers with less appealing cover templates for a book will likely be used less frequently than designers with more appealing cover templates. Publishers could rank their satisfaction with various contributors to the customized content so that shared history and ranking could be used to build trust in the system.

Once a publication has been created, it is delivered 280. Delivery 280 includes putting the publication in its deliverable form. The publication can be delivered to certain (or all) recipients as electronic files (e.g., via the Internet), or the publication can be delivered to certain (or all) recipients as print products. Examples of print products include, without limitation, photo albums, newspapers, journals, catalogs, pamphlets, travel guides, post cards, signage, product packaging. books, booklets, and magazines.

For certain publications, a print product might require a certain print media type or color properties (e.g., CMYK, CMYKcm, hexachrome or larger gamut). Moreover, creating a print product can involve more than simply printing. A print product might require specialty services, such as applying bindings, special finishes, etc. The information store may include information about different print service providers 219 that allow a publisher to select one or more of them to create the print products.

For some publications, a single print service provider could fulfill all of a publisher's requirements. For certain other publications, however, it might be more efficient to distribute the print product creation among several print service providers. Print service providers can be differentiated by specialty capabilities and location. For example, a print service provider is selected according to efficient resource allocation and geography. Print services providers can be differentiated in other ways, such as superior services.

Other factors may be considered in selecting print service providers. For instance, a print service provider might offer an incentive system that encourages customers to use its services. One incentive system is a points system, where a customer gets points for using a print service provider. The points may accrue according to number of prints, dollar purchases, free printing pages, etc. Incentives could include monetary incentives, print credits, product upgrades, fulfillment upgrades, etc.

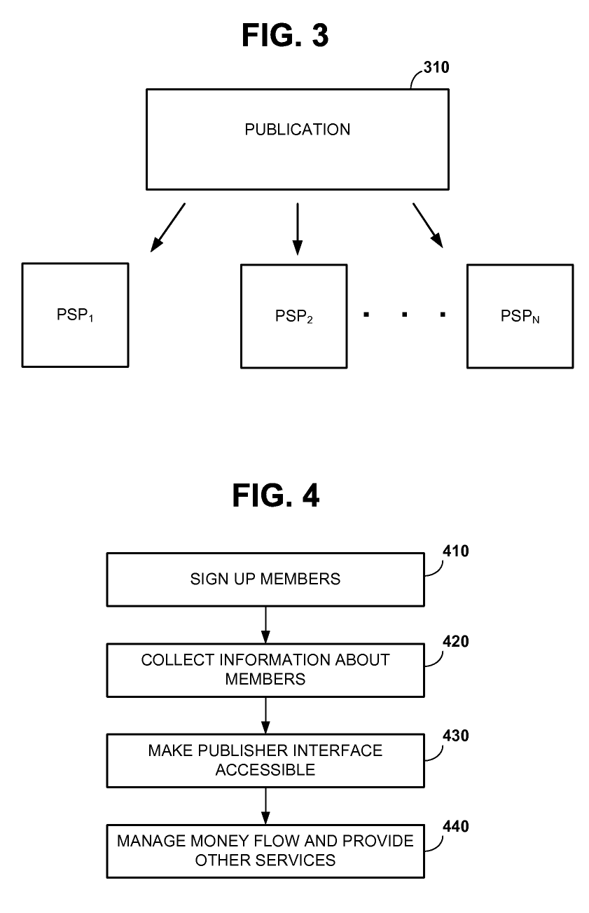

Reference is made to FIG. 3, which illustrates distributed printing of a publication 310 among different print service providers PSP₁-PSP_{N}. The different print service providers PSP₁-PSP_{N} could be distinguished by different capability and geography. Print service providers PSP₁-PSP_{N} could be selected according to efficient resource allocation and geography. Print service providers PSP₁-PSP_{N} could also be selected according to an accrued points system.

A publication can be sent in its entirety to a print service provider. Or, different portions of a publication can be sent to different print service providers, who then print the portions and send the printed portions to a central location for assembly into print products.

The publisher interface 230 can be used to manage other functions, such as the flow of money between the parties. For example, a content provider could use the publisher interface to collect royalties, a subscriber could use the interface to pay a subscription fee, etc.

The publisher interface can also allow publishers to show on-line versions of their publications to members and others. A publisher can use this advertising feature to inform members and others about a particular publication, and entice those who are interested to subscribe to the publication.

All of this capability is at the fingertips of a publisher. A publisher doesn't need to understand the intricacies of document publishing. A publisher doesn't need to establish a network of content providers, designers, advertisers.

A system according to the present invention expands the available resources for creating publications, far beyond those offered by desktop publishing software. Such a system offers access to a wide variety of resources (e.g., content providers, designers, advertisers, editors, print service providers) of varying degrees of quality. A person with little or no knowledge of desktop publishing can use such a system to create a professional-looking publication.

A system according to the present invention allows relatively inexperienced people to collaborate with those having expertise in and knowledge of specific roles in the creation of publications. Such a system even allows experienced people to expand their network of content providers, editors, designers and other professionals who create publications.

A web-based system is particularly advantageous, since it is available to anyone who has Internet access. A web-based system can be used to provide an on-line service for creating publications.

A system according to the present invention can be used to solicit bids from advertisers for advertising space in a publication. For example, a publisher can create a publication (with or without the publisher interface) and use the publisher interface to solicit bids from advertisers. Advertisements in the publication could be used to subsidize the cost of the publication.

An entire publication need not be created by a single publisher. Different publishers can take “ownership” of different portions of a single publication.

The creation of publications is scalable. At one end of the scale is the creation of widely circulated professional publications. At the other end of the scale is the creation of publications for a select few recipients. The following provides but a few examples of how a system according to the present invention can be used to create publications.

As a first example a person wants to print a large collection of vacation photos. Using the publisher interface, the person contracts with a designer to do specific image editing and an art nouveau layout. Using the publisher interface, the person supplies images of family members taken during the vacation. The publisher interface also provides access to previews of other images at the vacation location, which images were taken by freelance and amateur photographers. The publisher interface also reveals professional content (e.g., stories) about the vacation location. The publisher interface allows the person to pay a variable amount for this professional content. The system then parses the text in the professional content and infers that it is about travel to that vacation location during a specific time period. Using this inference, the system finds potential advertisers that would choose to subsidize the printing costs for relevant content. After the publication has been created, the person provides public feedback on the various members who contributed to the publication.

As a second example, a publisher requests multiple editors to create a publication. The multiple editors “own” and contribute to predefined sections of the publication via the publisher interface. These editors could be professionals or they could be others working as part of a group such as a publication house, friends, family, social group, organization, etc. The editors take it upon themselves to create different sections of the publication. Consider a “family—keep in touch” magazine that is published monthly. Several family members collaborate to create this magazine, each taking ownership of a different section of the magazine. Each family member uses a publisher interface to add family stories and other content.

As a third example, a printed publication is created by an affinity web group. The group subscribes to a printed publication as a derivative of their web site. The publications can include professional articles in combination with local articles that might be of interest to the affinity web group. For a fan magazine, content about a celebrity from a fan web site or other source could be combined with fan letters.

As other examples a publisher uses a publisher interface to create club newsletters, social group newsletters, magazines and news and reviews, which can combine different languages based on interest or origin of story. A publisher can use a publisher interface to create school and university newsletters by bringing together editors, contributors and owners from different departments (e.g., sports, general, social activity, class or grade level, national and city level councils, PTA). These publications might include combinations of self contribution and third party royalty and non-royalty based articles.

As still other examples, owners of other content customized with a topical focus (e.g., pets, automobiles, collectibles) could partner with traditional publishing companies with databases of current legacy content relating to the content. A custom publication for a youth league soccer team might choose to purchase some images from a nationally-known sports magazine. A neighborhood association of a coastal community might choose to purchase some articles from a home and garden magazine and combine that content with their own.

A system according to an embodiment of the present invention can allow different publishers to work with each other. A publisher might choose to license its content to other publishers directly. For example, a person in San Francisco might allow a person in Wisconsin to include his picture of the Golden Gate Bridge in his collection of vacation photos to northern California for a nominal fee.

Reference is now made to FIG. 4, which illustrates a method of providing a publishing service to members. At block 410, different parties are signed up as members of the service.

At block 420, information is collected about the different members (e.g., content providers, designer, editors, advertisers) who can contribute to the creation of publications. The information, which allows a publisher to select certain of the members to create a particular publication, is stored in an information store.

Member information could be obtained actively. Members could be asked to fill out questionnaires, surveys, registration forms, etc. Information could be provided by parties knowledgeable about members. The information may be entered via a publisher interface or other means.

Member information can also be obtained passively. Information could be obtained by searching data. Public databases and private databases (e.g., CRMS) could be searched.

Member information could be obtained before, while, or after a publication is created. The information can be continually updated, refined, and expanded upon. Information about members could be added to the information store.

At block 430, a publisher interface is made accessible. The publisher interface allows a publisher to search the information store to identify members who can create a particular publication.

Publishers don't have to be members of the service. However, publishers who are members could have access to additional services (block 440). A member might be entitled to printing services such as higher quality digital commercial printing, color and soft proofing. A publishing service provider could enable subscribers to get additional subsidization and printing points by referring others to the publishing service provider or by closing purchases through the targeted ads in their publications. Other member services might include managing the flow of money between the various members. The publishing service provider could facilitate the payment of royalties to content providers for their content. The publishing service provider could facilitate the payment of royalties to designers for usage of their designs, templates and styling sheets. These are but a few examples.

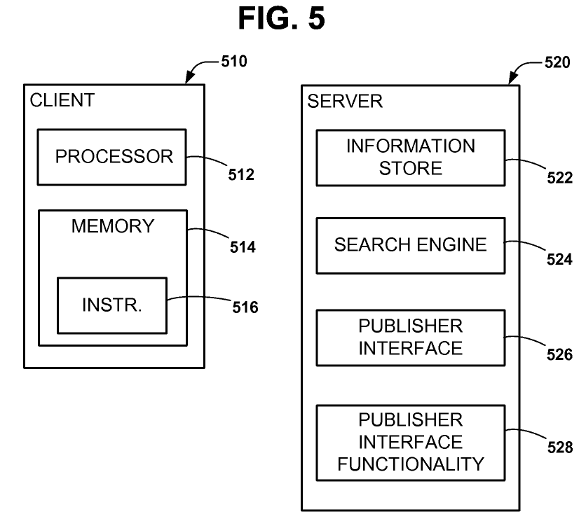

Reference is now made to FIG. 5, which illustrates an exemplary client 510 and server 520. The client 510 may be a machine that includes a processor 512 and memory 514 that stores instructions 516 for causing the processor 512 to run the publisher interface. The client 510 is not limited to any particular type of machine. Example of such machines include, without limitation, computers (e.g., desktop, laptop, PDAs and other handheld), mobile phones, printers, portable media players, gaming consoles, video cameras and digital cameras. The publisher interface can be implemented as a dedicated application, a web browser, etc.

A publisher interface can be integrated with a search engine, image processing software (e.g., a photo editor), image display software (e.g., a photo album), file manager, or other suitable software. A publisher interface can be integrated with an operating system.

Another example of a client 510 is a kiosk. The kiosk includes a publisher interface, internet access to an information store, a location-specific printer, a mobile telecom, and a portable device that collects media and tags with an RFID reader or spot (location) reader. Consider a kiosk at a zoo. A tourist uses a digital image capture device (e.g., digital camera, cell phone) to take digital images of children at designated spots in front of different animals. The digital device adds tags to the digital images. The tags indicate the locations at which the images were taken. The tags can be added, manually or automatically, for instance, with a GPS system. The kiosk processes these digital images, which includes identifying the locations via the tags. Then, the kiosk extracts images of the children at each location, accesses professionally-taken images of the locations (which can be provided by the zoo), and superimposes the extracted images of the children over the professionally-taken images.

The server 520 may store a search engine 524 and an information store 522. The server 520 may also store an entire publisher interface 526, instances of which may be downloaded by clients 510. Or the server 520 may store data 528 (e.g., web pages, applets, script) that is downloaded to a client device to give functionality to a web browser or some other application.

A system according to the present invention is not limited to a client-server architecture. Other architectures, such as peer-to-peer, could be used instead of, or in addition to, the client-server architecture.

In the case of a collective edition or a publication with a large amount of distributed content, a peer-to-peer architecture could be used to distribute a more complete collection of source content, which is subsequently reduced, refined or supplemented by publishers or others. Consider a public event that has a broad audience appeal, such as a championship game. A collective edition for the victors is assembled by a large number of fans sharing their source content and adding their own. The original raw material for that event might be large and diverse, for example hundreds of images or gigabytes of data. However, the peer-to-peer network would allow efficient distribution of the content, since bottlenecks at a central server would be avoided.

A system according to the present invention is not limited to the creation and distribution of a generic publication for all recipients. In some embodiments, the publication can be customized for different recipients. That is, each recipient receives a customized instance of a publication, where the instance is customized according to that recipient's interests.

Each recipient may be an individual person or a group of people having a common interest or a set of common interests. Recipient interests might include geographic location, reading interests, hobbies, affiliations, memberships, desired level of advertising, etc.

Each instance of the publication may contain common content, a common design, and common advertisements. However, each instance also contains features that are selected according to its recipient's interests. An instance may contain customized content (e.g., stories of interest, regional information, certain editorials, photos from specific places of interest to a recipient). An instance may contain a customized design (e.g., an appropriate template or style sheet, a theme for special occasion, a layout with cartographic styles for a recipient interested in travel, use of a predominant color for a holiday, certain image borders or frames, fonts, page numbers and other graphical elements).

An instance may contain customized advertisements. Advertisements in an instance may be targeted to the specific interests of a recipient. For example, if a recipient expresses an interest in amateur photography, the customized instance might include advertisements by camera makers, memory card manufacturers, etc.

In addition, the level of advertising in an instance may be customized to its recipient's interests. For example, a recipient might be willing to pay full cost for an instance, provided that the instance does not contain advertising. Or a recipient might accept a certain amount of advertising in an instance so that the instance is subsidized in part by advertisements. As a result, the recipient's cost of the instance would be reduced.

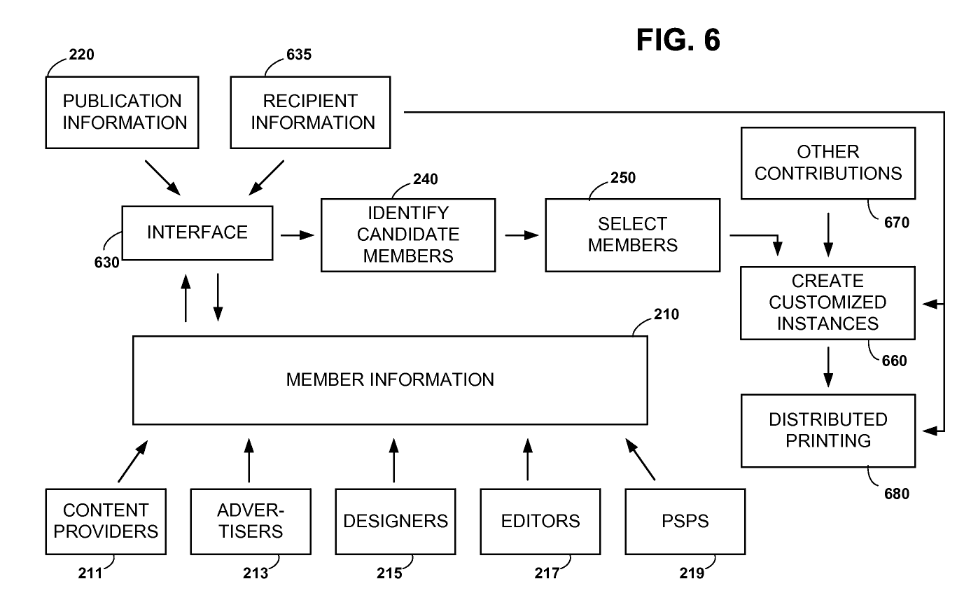

Reference is now made to FIG. 6, which illustrates the creation of customized instances of a publication. The creation of customized instances as illustrated in FIG. 6 is similar to the creation of publications as illustrated in FIG. 2. These common features will be referenced by the same numerals. Different features will be referenced by different numerals.

In the example of FIG. 6, the information store contains information 210 about the following types of members: content providers 211, advertisers 213, designers 215, editors 217, and print service providers 219.

To create a publication, a publisher accesses a publisher interface 630, which queries the publisher for information 220 about the publication.

The interface 630 is also configured to gather information 635 about recipient interests. The information can be gathered by querying the publisher for information about recipient interests. The information can also be gathered by searching databases that contain recipient information. The recipient information may be ascertained from historical behavior. For example, recipient information could be ascertained from credit card and other shopping purchases, search history (e.g., queries that recipients submit to search engines), movie ratings (e.g., Netflix), travel history, educational history, books read, etc. The recipient information may also be ascertained from anticipated or future actions. For example, recipient information could be ascertained from travel plans, product inquiries, technical reviews that have been accessed, etc.

The publication service provider uses a search engine to search the member information 210 to identify candidate members 240 who might be (but are not necessarily) interested in creating the publication. The publisher then selects members 250 to create the customized instances of the publication.

The selected members then create customized instances of the publication 660. During initial iterations, a common design, common advertisements, common content and other common features are added to all instances. During additional iterations, customized features are added to each instance.

The customized instances could include contributions 670 by the publisher and subscribers. Subscribers may also provide information about recipient interests.

After the customized instances have been created, they are printed 680 or otherwise delivered. Distributed printing among different print service providers can become especially valuable if the customized instances are delivered as print products. There might be high setup costs associated with sending all of the customized instances to a single print service provider. For example, some recipients might want their instances printed in black and white, whereas other recipients might want their instances printed in color. Different recipients might want different media type, color properties, binding options, gloss finishing, use of metallic colorants, use of non-standard or specialty fonts, dust jackets, etc By selecting print service providers according to recipient information, an efficient allocation of resources can be achieved, and set-up costs can be reduced.

The following provides but a few examples of customized instances of a publication. A publisher wants to create a unique version of a publication by submitting or competing for inclusion in a topical publication, such as a regional cookbook in with publisher voting for the best recipes by neighborhood. Only specific chapters are included for specific recipients.

A customized travel magazine is created from mashup content. The content is selected from individual publications such as AAA, Lonely Planet, National Geographic, etc. The content for each instance is selected according to its recipient's interests.

Another example of a customized instance is a user-customized or collective edition created for a shared event, location or other shared experience. For example the history and sale of a corporate dunking tank could be created uniquely for each individual according to their own content and history, but supplemented with other content and templates.

A system according to the present invention is not limited to print products and electronic files. In some embodiments, the publications could be multimedia products such as audio clips, video clips (e.g., for YouTube), radio, and television. The publications could be created and delivered as streaming media, electronic files, or in some other form. Other examples of other publications include software, blogs, and RSS feeds.

1. A publishing system comprising apparatus for providing a publisher interface that is dedicated to receive information about creating a publication and that is also dedicated to initiate a search of an information store containing information about different members who can contribute to various phases of publication creation, the information store searched to identify at least one member who can contribute to the creating of the publication.

2. The system of claim 1, further comprising at least part of the information store.

3. The system of claim 1, wherein the interface is web-based.

4. The system of claim 3, wherein the apparatus includes a server for providing the interface via a network.

5. The system of claim 1, wherein the members include at least some of content providers, designers, editors, and advertisers.

6. The system of claim 1, wherein the interface is dedicated to directly identify the different members.

7. The system of claim 1, wherein the interface is dedicated to inform different members that a publication will be created in order to solicit interest in creating the publication.

8. The system of claim 7, wherein the interface is dedicated to accept bids from interested members.

9. The system of claim 1, wherein the information store contains information that allows the search engine to ranks the members.

10. The system of claim 1, wherein the information store also contains feedback about the members.

11. The system of claim 1, wherein the interface also searches for print service providers so printing of the publication can be distributed.

12. The system of claim 11, wherein the information store contains information that allows the interface to select multiple print service providers according to efficient resource allocation.

13. The system of claim 11, wherein the information store also contains information about an accrued points system so a print service provider can be selected according to accrued points.

14. The system of claim 1, wherein the interface is dedicated to manage money flow between members.

15. The system of claim 1, wherein the publisher interface is dedicated to access a template for the publication.

16. The system of claim 1, wherein the information store provides access to proprietary content, and wherein the interface is dedicated to select proprietary material and obtain Intellectual Property rights.

17. A method comprising obtaining content and using the system of claim 1 to create a publication from the obtained content.

18. A method comprising creating a publication and using the system of claim 1 to solicit bids from advertisers for advertising space in the publication.

19. A method comprising using the system of claim 1 to provide an on-line service for creating publications.

20. A publishing method comprising:
signing up different members who can contribute to the creation of publications;
collecting information about the members, wherein the information allows a publisher to select certain of the members to create a particular publication; and
providing a publisher interface that allows a publisher to search the information to identify members who can create a particular publication.

21. The method of claim 20, wherein the user interface also allows the member information to be collected.

22. A publishing system comprising:
a searchable information store containing information about members who can contribute to various phases of publication creation; and
an interface for entering information about creating a publication and for searching the information store to identify at least one of the members to contribute to creating of the publication.

23. An article comprising memory encoded with instructions that cause a client device to request information about creating a publication and that also causes the client device to initiate a search of an information store, the information store containing information about different members who can contribute to various phases of publication creation, the information store searched to identify at least one member who can contribute to the creating of the publication.
